SEQUENCE LISTING (2 sequences)

SEQ ID NO: 1 - DNA, 19 bp, synthetic construct
  source 1..19: mol_type = other DNA
gtgccagcmgccgcggtaa

SEQ ID NO: 2 - DNA, 20 bp, synthetic construct
  source 1..20: mol_type = other DNA
ggactachvgggtwtctaat

(19) United States
(12) Patent Application Publication
(10) Pub. No.: US 2025/0074803 A1
(43) Pub. Date: Mar. 6, 2025

(54) SYSTEM AND METHOD OF HIGH EFFICACY TWO-STAGE METAL TREATMENT INCORPORATING BASIC OXYGEN FURNACE SLAG AND MICROBIAL SULFATE REDUCTION

(71) Applicants: Dennis Grubb, Philadelphia, PA (US); Arizona Board of Regents on behalf of Arizona State University, Scottsdale, AZ (US); FREEPORT MINERALS CORPORATION, Phoenix, AZ (US)

(72) Inventors: Anca Delgado, Tempe, AZ (US); Evelyn Miranda, Tempe, AZ (US); Nasser Hamdan, Scottsdale, AZ (US); Leonard Santisteban, Sahuarita, AZ (US); Dennis Grubb, Philadelphia, PA (US)

(21) Appl. No.: 18/820,649

(22) Filed: Aug. 30, 2024

Related U.S. Application Data
(60) Provisional application No. 63/580,240, filed on Sep. 1, 2023.

(51) Int. Cl. C02F 3/34; C02F 3/28; C02F 101/10; C02F 101/20; C02F 103/10

(52) U.S. Cl. CPC C02F 3/345; C02F 3/286; C02F 2101/101; C02F 2101/20; C02F 2103/10

(57) ABSTRACT

Described herein is a method of purifying contaminated fluid influent, the method comprising: providing a reactor comprising a reactor inlet, a reactor outlet, and a purification composition; circulating contaminated fluid influent through the reactor to create a slag-treated fluid; providing a biochemical reactor comprising a biochemical reactor inlet, a biochemical reactor outlet, and a purification media; and circulating the slag-treated fluid through the biochemical reactor to generate a purified fluid. Also described herein is a contaminated fluid influent purification system, comprising: a reactor having a reactor inlet, a reactor outlet, and a purification composition; a biochemical reactor having a biochemical reactor inlet, a biochemical outlet, and a purification media; a settling tank; and a mixing tank; wherein the mixing tank is fluidly connected to a contaminated fluid influent source, the reactor and the settling tank; and wherein the settling tank is fluidly connected to the mixing tank and the biochemical reactor.

### CROSS-REFERENCE TO RELATED APPLICATIONS

The present application claims priority to U.S. Provisional Application No. 63/580,240, filed Sep. 1, 2023, which is incorporated by reference herein in its entirety.

### STATEMENT REGARDING FEDERALLY SPONSORED RESEARCH OR DEVELOPMENT

This invention was made with government support under 1449501 awarded by the National Science Foundation. The government has certain rights in the invention.

### INCORPORATION BY REFERENCE OF A SEQUENCE LISTING SUBMITTED AS AN XML FILE

The Sequence Listing file in XML format titled “206339_0097_00US_SequenceListing.xml”, having a creation date of Aug. 29, 2024 and file size of 2,809 bytes in size, is hereby incorporated by reference in its entirety.

### BACKGROUND OF THE INVENTION

A pertinent environmental challenge at mining sites worldwide is the formation of mining-influenced water (MIW), such as rock/mine drainage, when excavated pyrite (Fe₂S)-bearing rocks are exposed to water and toxic conditions, initiating Fe₂S abiotic and microbial oxidation. MIW streams are often acidic (pH 2-3) and may contain elevated concentrations of heavy metals and metalloids, such as iron (Fe), aluminum (Al), copper (Cu), zinc (Zn), lead (Pb), arsenic (As), among others. Because MIW may pose a threat to wildlife ecology and water resources, it requires treatment strategies to limit metal(loid) mobility and exposure.

Sulfate-reducing biochemical reactors (SRBRs) are a type of treatment technology for MIW, most often used at remote and/or abandoned mining sites. The development of SRBRs began in the late 1980s based on observations and microbiological principles from anaerobic wetlands containing plant material high in lignocellulose. The first field-scale SRBRs were implemented in the early 1990s at an underground mining site and a smelting residue dumping site in Pennsylvania, USA. These early SRBRs used spent mushroom compost as packing material and demonstrated effective removal of Al, cadmium (Cd), Fe, manganese (Mn), nickel (Ni), and Zn from acidic and near-neutral MIW streams.

The appeal of lignocellulosic SRBRs for MIW treatment stems from their relatively low-cost, minimal maintenance, and installation suitability especially when needed at the most remote mining locations. The more modern SRBRs are constructed as packed-bed bioreactors in columns, tanks, or in lined dugouts, depending on the scale; many SRBR designs continue to employ lignocellulose packing. Lignocellulose is the major component in plant cell walls and is mainly composed of cellulose (glucose polymers), hemicellulose (xylose and other sugar polymers), and lignin (lignol polymers). Examples of material used in SRBRs include alfalfa hay, straw, other grasses (high cellulose/hemicellulose content) and sawdust, wood chips, nut shells (high lignin content). Hemicellulose and cellulose are more biodegradable than lignin under anaerobic conditions. The selection of the packing materials reflects a balance between the biodegradation potential of the lignocellulose, the porosity of the material for effective MIW flow and clogging prevention, and the longevity of the material for long-term operation.

Treatment of MIW via lignocellulosic SRBRs relies on an anerobic syntrophic microbial community with specific functions. Hydrolytic and fermenting bacteria break down lignocellulose polymers to monomers and simple products of fermentation, such as organic acids, alcohols, and H₂. These fermentation products are then utilized by sulfate-reducing bacteria as electron donors to reduce sulfate (terminal electron acceptor) to sulfides (H₂S, HS⁻, S²⁻). Sulfate-reduction increases pH via bicarbonate production and removes dissolved metal(loids) from MIW primarily as relatively insoluble sulfide precipitates.

Sulfate-reducing bacteria pertinent to MIW treatment require a pH above 4. A strategy to provide an additional source of alkalinity and manage the acidic pH of MIW is to pack SRBRs with a mix of lignocellulosic material and limestone (CaCO₃). Limestone can account for 10 to 80% of the total weight of the packed material in an SRBR. Limestone can also be used as a chemical pre-treatment step for MIW (e.g., limestone reactor) before treatment by an SRB. However, limestone's ability to raise MIW pH decreases overtime due to passivation or armoring. Managing the pH in MIW treatment is critical as the pH controls both the microbial activity and metal(loid) precipitation in an SRBR, therefore identification of novel or more effective materials to support SRBR longevity and treatment efficacy is essential.

Thus, there is a need in the art for improved compositions and methods for MIW treatment. This invention satisfies this unmet need.

### SUMMARY OF THE INVENTION

In one aspect, the current invention relates to a method of purifying contaminated fluid, the method comprising: a reactor comprising a reactor inlet, a reactor outlet, and a purification composition; circulating contaminated fluid influent through the reactor to create a slag-treated fluid; providing a biochemical reactor comprising a biochemical reactor inlet, a biochemical reactor outlet, and a purification media; and circulating the slag-treated fluid through the biochemical reactor to generate a purified fluid. In one embodiment, the purified fluid is collected. In one embodiment, the purification composition comprises slag and a dispersing component. In one embodiment, the slag is a basic oxygen furnace slag. In one embodiment, the purification media comprises a lignocellulosic component and sulfate reducing bacteria. In one embodiment, the slag-treated fluid has a pH of at least 4. In one embodiment, the method further comprises the step of pumping the slag-treated fluid to a mixing tank which contains contaminated fluid influent. In one embodiment, the method further comprises the step of mixing the slag-treated fluid with contaminated fluid influent in the mixing tank to create a mixed stream. In one embodiment, the method further comprises the step of partially recycling the mixed stream back through the reactor inlet. In one embodiment, the method further comprises the step of passing the mixed stream to a settling tank to create a pretreated fluid. In one embodiment, the method further comprises the step of passing the pretreated fluid to and through the biochemical reactor to generate a purified fluid. In one embodiment, the pretreated fluid comprises less metal(loids) than the mixed stream.

In one aspect, the current invention relates to a contaminated fluid influent purification system, comprising: a reactor having a reactor inlet, a reactor outlet, and a purification composition; a biochemical reactor having a biochemical reactor inlet, a biochemical outlet, and a purification media; a settling tank and a mixing tank; wherein the mixing tank is fluidly connected to a contaminated fluid influent source, the reactor and the settling tank; and wherein the settling tank is fluidly connected to the mixing tank and the biochemical reactor. In one embodiment, the purification composition comprises slag and a dispersing component. In one embodiment, the slag is a basic oxygen furnace slag. In one embodiment, the purification media comprises a lignocellulosic component and sulfate-reducing bacteria. In one embodiment, the lignocellulosic component comprises sugarcane bagasse. In one embodiment, the lignocellulosic component comprises spent brewing grains. In one embodiment, the contaminated fluid influent comprises fluid contaminated with metals. In one embodiment, the contaminated fluid influent comprises mining influenced water.

### BRIEF DESCRIPTION OF THE DRAWINGS

The following detailed description of embodiments of the invention will be better understood when read in conjunction with the appended drawings. It should be understood that the invention is not limited to the precise arrangements and instrumentalities of the embodiments shown in the drawings.

FIG. 1 depicts a configuration of the two-stage treatment in this study employing a basic oxygen furnace slag reactor and sulfate-reducing biochemical reactors (SRBRs). The solid arrows show liquid flow while the dashed arrows indicate the flow of excess gas to a concentrated solution of NaOH. The green circles show approximate locations where the SRBR contents were sampled at the end of operation: T=top of SRBR (closest to influent); M1, M2, and M3=locations in the middle of the SRBR; B=bottom of SRBR (closest to effluent).

FIG. 2, comprising FIG. 2A through FIG. 2O, depicts the results of exemplary experiments compiling the measurements from the 121 days of operation at the slag and SRBR stages of treatment. FIGS. 2A, FIG. 2B, and FIG. 2C depict effective changes in pH and HRT values. FIGS. 2D, FIG. 2E, and FIG. 2F depict oxidation reduction potentials (ORP). FIGS. 2G, FIG. 2H, and FIG. 2I depict dissolved oxygen (DO). FIGS. 2J, FIG. 2K, and FIG. 2L depict SO₄²⁻ concentration and removal. FIGS. 2M, FIG. 2N, and FIG. 2O depict total metal(loid) concentrations and removal in the slag stage and the SRBR stages of treatment. Empty symbols show influent MIW concentrations while filled symbols show effluent concentrations. SRBR data are averages with standard deviation of duplicates.

FIG. 3, comprising FIG. 3A through FIG. 3E, depicts the microbial community compositions of the slag and SRBR stages and analyzes their lignocellulosic components (cellulose, hemicellulose, lignin) and non-lignocellulosic (sugars, starches, proteins) components. The total organic acid and alcohol production is also presented. FIG. 3A depicts the microbial community composition at various taxonomic levels in the inocula and SRBRs at the end of operation. FIG. 3B and FIG. 3C depict the lignocellulose composition before (day 0) and at the end of operation (day 121) in 5 sections of the SRBRs. FIG. 3D and FIG. 3E depict the total organic acid/alcohol concentrations and production throughout SRBR operation. FIGS. 3F and 3G depict a weighted UnifFac diversity analysis using samples from SRBRs packed with spent brewing grains or sugarcane bagasse receiving MIW pretreated by slag and samples from SRBRs packed with spent brewing grains or sugarcane bagasse and 30% limestone. Abbreviations: SRBR=sulfate-reducing biochemical reactor; ADS=anaerobic digestor sludge; grains=spent brewing grains, bagasse=sugarcane bagasse, enrichment=microcosm enrichment culture, T=SRBR top (influent side), M2=SRBR middle location #2, B=SRBR bottom (effluent side). The data points from FIGS. 3A through 3D are averages and include standard deviations from experiments with duplicate SRBRs.

FIG. 4 depicts an image of the two-stage treatment involving basic oxygen furnace slag and sulfate-reducing biochemical reactors (SRBRs) during operation.

FIG. 5, depicting FIG. 5A and FIG. 5B, depicts the effluent concentrations of S²⁻ (primary y axis) and S²⁻ production. FIG. 5A depicts the effluent concentrations of S²⁻ (primary y axis) and S²⁻ production in the spent brewing grains SRBRs during operation. FIG. 5B depicts the effluent concentrations of S²⁻ (primary y axis) and S²⁻ production in the sugarcane bagasse SRBRs during operation. The data are averages with standard deviations of duplicate SRBRs.

FIG. 6, comprising FIG. 6A through FIG. 6C, depicts the microbial community diversity analysis in the inocula and SRBRs at the end of operation. FIG. 6A depicts Bray-Curtis diversity analysis. FIG. 6B depicts Faith's phylogenetic diversity indices. FIG. 6C depicts Pielou's evenness indices. Abbreviations: ADS=anaerobic digestor sludge; grains=spent brewing grains; bagasse=sugarcane bagasse; enrichment=microcosm enrichment culture SRBR=sulfate-reducing biochemical reactor.

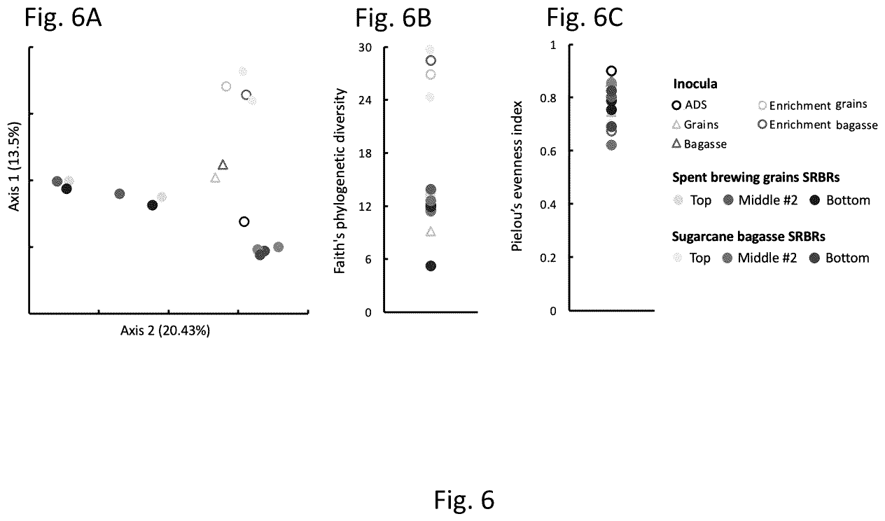

FIG. 7, comprising FIG. 7A and FIG. 7B, depicts the concentrations of fermentation products measured in the effluent. FIG. 7A depicts concentrations of fermentation products measured in spent brewing grains SRBRs. FIG. 7B depicts concentrations of fermentation products measured in sugarcane bagasse SRBRs during operation. The data are averages with standard deviation of duplicate SRBRs.

FIG. 8 depicts exemplary method 800.

FIG. 9 depicts exemplary method 900.

FIG. 10 depicts exemplary method 1000.

### DETAILED DESCRIPTION

It is to be understood that the Figures and descriptions of the present invention have been simplified to illustrate elements that are relevant for a clear understanding of the present invention, while eliminating, for the purpose of clarity, many other elements used in mining influenced water purification. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, or ±0.1% from the specified value, as such variations are appropriate to perform the disclosed methods.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### DESCRIPTION

The present invention relates to a purification system comprising vessels packed with basic oxygen furnace slag and a vessel containing lignocellulose material to support sulfate-reducing bacteria and methods of purification of contaminated fluids using said vessels and methods. As contemplated herein, the present invention includes a two-stage design, comprising a slag stage wherein the contaminated fluid influent is treated before entering the sulfate-reducing biochemical reactor stage in series.

### Purification System

The present invention relates in part to a contaminated fluid influent purification system comprising a slag stage and a sulfate-reducing biochemical reactor stage. In one aspect, the contaminated fluid purification system comprises a reactor, a reactor inlet, a reactor outlet, and a purification composition; and a biochemical reactor comprising a biochemical reactor inlet, a biochemical reactor outlet, and a purification media. In one embodiment, the contaminated fluid influent purification system further comprises a settling tank and a mixing tank, wherein the mixing tank is fluidly connected to a contaminated fluid influent source, the reactor, and the settling tank; and wherein the settling tank is fluidly connected to the mixing tank and the biochemical reactor.

In one embodiment, the purification composition in the reactor comprises slag and a dispersing component. In one embodiment, the purification media in the biochemical reactor comprises a lignocellulosic component and sulfate-reducing microbial community containing hydrolytic and fermenting bacteria and sulfate-reducing bacteria. In one embodiment, the contaminated fluid influent is pumped from a contaminated fluid influent source, through the reactor inlet, out the reactor outlet, and to the mixing tank. In one embodiment, pumping the contaminated fluid influent through the reactor raises the pH of the influent, decreases the contaminated fluid influent oxidation reduction potential, decreases dissolved oxygen concentrations, and removes metal(loids). In one embodiment, the reactor outlet is fluidly connected to mixing tank. In one embodiment, the mixing tank is fluidly connected to the reactor inlet to complete a closed loop. In one embodiment, the mixing tank is fluidly connected to a contaminated fluid influent source which feeds the mixing tank contaminated fluid. In one embodiment, the same mixing tank is fluidly connected to a settling tank. In one embodiment the settling tank is fluidly connected to the biochemical reactor inlet. In one embodiment the biochemical reactor outlet is fluidly connected to collection vessel.

The contaminated fluid influent may comprise any type of acidic wastewater containing heavy metal or metal(loid) ions. In one embodiment, the contaminated fluid influent comprises seepages. In one embodiment, the contaminated fluid influent comprises acidic process waste streams. In one embodiment, the contaminated fluid influent is sewage wastewater. In one embodiment, the contaminated fluid influent comprises excavation wastewater. In one embodiment, the contaminated fluid influent comprises byproduct gypsum. In one embodiment, the contaminated fluid influent comprises mining process chemicals including, but not limited to, cyanide, sodium cyanide, sulfuric acid, ammonium nitrate, acetylenes, acetic acid, sodium nitrate, sodium perchlorate, peroximes, alkyl oximes, aryl oximes, sulfosuccinates, and xanthane salts.

In one embodiment, the purification composition in the reactor comprises basic-oxygen-furnace slag which is a type of steel slag. As the contaminated fluid influent passes through the reactor, the contaminated fluid influent is alkalized, and metal(loids) are precipitated and adsorbed, reducing metal(loid) levels. The slag may comprise any type of slag generated from the iron and steel making industries which include, but are not limited to, blast-furnace slag (ironmaking slag), electric-arc-furnace (EAF) slag, and ladle slag. In one embodiment, the reactor comprises a combination of different types of slag. In one embodiment, the purification composition comprises between 10% and 90% of the total volume of the reactor. In one embodiment, the purification composition comprises between 20% and 90% of the total volume of the reactor. In some embodiments, the purification composition comprises between 30% and 90% of the total volume of the reactor. In some embodiments, the purification composition comprises between 40% and 90% of the total volume of the reactor. In some embodiments, the purification composition comprises between 50% and 90% of the total volume of the reactor. In some embodiments, the purification composition comprises between 60% and 80% of the total volume of the reactor.

The slag may comprise any particle size. In one embodiment, the slag is a coarse slag with at least 1 mm diameter. In one embodiment, the slag has at least a 1 mm diameter. In one embodiment, the slag has a diameter of at least 10 mm in diameter. In one embodiment, the slag has a diameter of at least 100 mm in diameter. In one embodiment, the slag has a diameter of at least 1000 mm in diameter. In one embodiment, the slag has a particle diameter between 1 and 100 mm. In one embodiment, the slag has a particle diameter between 1 and 75 mm. In one embodiment, the slag has a particle diameter between 1 and 50 mm. In one embodiment, the slag has a particle diameter between 1 and 40 mm. In one embodiment, the slag has a particle diameter between 1 and 30 mm. In one embodiment, the slag has a particle diameter between 1 and 20 mm. In one embodiment, the slag has a particle diameter between 9 and 20 mm.

In one embodiment, the reactor comprises a top layer with a dispersing component to help uniformly distribute the contaminated fluid influent before reaching the purification composition. In one embodiment, the top layer comprises sand. In one embodiment, the top layer comprises silica sand. In one embodiment, the top layer comprises quartz sand. In one embodiment, the top layer comprises organic polymer. In one embodiment, the top layer comprises small molecules. In one embodiment, the top layer comprises beads. In one embodiment, the top layer comprises nanoparticles. In one embodiment, the top layer comprises gravel. In one embodiment, the top layer comprises at least 1% of the total volume in the reactor. In one embodiment, the top layer comprises between 2% and 20% of the total volume in the reactor. In one embodiment, the top layer comprises 8.6% total volume in the reactor. In one embodiment, the top layer comprises at least 25% of the total volume in the reactor.

In some embodiments, the purification composition comprises a dispersing component, which in certain instances helps uniformly distribute the contaminated fluid influent throughout the purification composition. In one embodiment, the dispersing component comprises sand. In one embodiment, the dispersing comprises organic polymer. In one embodiment, the dispersing component comprises small molecules. In one embodiment, the dispersing component comprises beads. In one embodiment, the dispersing component comprises nanoparticles. In one embodiment, the dispersing component comprises gravel. The reactor may comprise of a homogenous mixture of the dispersing component and slag comprising any ratio. In one embodiment, the ratio of dispersing component to slag is at least 1:99. In one embodiment, the ratio of dispersing component to slag is at least 1:1. In one embodiment, the ratio of dispersing component to slag is at least 7:3. In one embodiment, the ratio of dispersing component to slag is at least 99:1. The silica sand can be of any grade. In one embodiment the silica sand has a grade of 20/30. In one embodiment, the dispersing material can be glass or ceramic or other non-reactive material.

The present invention relates in part to a contaminated fluid influent purification system comprising at least one reactor. In one embodiment, contaminated fluid influent purification system comprises at least two reactors. In one embodiment, the contaminated fluid influent purification system comprises a plurality of reactors. In one contaminated fluid influent purification system is built around a series of reactors. In one embodiment, the reactors are mounted. In one embodiment, the reactors operate in parallel. In one embodiment, the reactors operate in series. Sets of reactors operating in series may be joined to other vessels containing purification media.

The present invention relates in part to a contaminated fluid influent purification system comprising at least one biochemical reactor. In one embodiment, contaminated fluid influent purification system comprises at least two biochemical reactors. In one embodiment, the contaminated fluid influent purification system comprises a plurality of biochemical reactors. In one contaminated fluid influent purification system is built around a series of biochemical reactors. In one embodiment, the reactors are mounted. In one embodiment, the biochemical reactors operate in parallel. In one embodiment, the biochemical reactors operate in series. Sets of biochemical reactors operating in series may be joined to other vessels containing purification media.

In one aspect, the purification media in the biochemical reactor also serves as microbial habitat and support. In one embodiment, the purification media comprises a lignocellulosic component. In one embodiment, the lignocellulosic component comprises sugarcane bagasse. In one embodiment, the lignocellulosic component comprises spent brewing grains. In one embodiment, the lignocellulosic component comprises spent mushroom compost. In one embodiment, the lignocellulosic component comprises alfalfa hay. In one embodiment, the lignocellulosic component comprises straw. In one embodiment, the lignocellulosic component comprises other grasses (high cellulose/hemicellulose content) and sawdust. In one embodiment, the lignocellulosic component comprises wood chips. In one embodiment, the lignocellulosic component comprises nut shells (high lignin content). In one embodiment, the lignocellulosic component comprises a mixture of slag and lignocellulose or limestone and lignocellulose. In one embodiment, the purification media comprises of a mixture of lignocellulose components. In one embodiment, the purification media in the biochemical reactor comprises at least 25% of the total volume. In one embodiment, the purification media in the biochemical reactor comprises at least 50% of the total volume. In one embodiment, the purification media in the biochemical reactor comprises between 50% and 98% of the total volume. In one embodiment, the purification media in the biochemical reactor comprises at least 78% of the total volume.

In one embodiment, the purification media in the biochemical reactor is inoculated with an anaerobic digestor sludge. In one embodiment, the anaerobic digestor sludge inoculum comprises between 0.5% and 10.0% of the total volume in the biochemical reactor. In one embodiment, the anaerobic digestor sludge inoculum comprises between 0.5% and 8.0% of the total volume in the biochemical reactor. In one embodiment, the anaerobic digestor sludge inoculum comprises between 0.5% and 6.0% of the total volume in the biochemical reactor. In one embodiment, the anaerobic digestor sludge inoculum comprises between 0.5% and 4.0% of the total volume in the biochemical reactor. In one embodiment, the anaerobic digestor sludge inoculum comprises between 1.0% and 3.0% of the total volume in the biochemical reactor. In one embodiment, the anaerobic digestor sludge inoculum comprises about 1% of the total volume in the biochemical reactor. In one embodiment, the anaerobic digestor sludge inoculum comprises about 1.5% of the total volume in the biochemical reactor. In one embodiment, the anaerobic digestor sludge inoculum comprises about 2.0% of the total volume in the biochemical reactor. In one embodiment, the anaerobic digestor sludge inoculum comprises about 2.5% of the total volume in the biochemical reactor. In one embodiment, the anaerobic digestor sludge inoculum comprises about 3.0% of the total volume in the biochemical reactor. In one embodiment, the anaerobic digestor sludge inoculum comprises about 3.5% of the total volume in the biochemical reactor. In one embodiment, the anaerobic digestor sludge inoculum comprises about 4.0% of the total volume in the biochemical reactor. In one embodiment, the anaerobic digestor sludge inoculum comprises about 4.5% of the total volume in the biochemical reactor. In one embodiment, the anaerobic digestor sludge inoculum comprises about 5.0% of the total volume in the biochemical reactor. In one embodiment, the anaerobic digestor sludge inoculum comprises at least 0.1% of the total volume in the biochemical reactor.

In one embodiment, the biochemical rector comprises a biodegrading and sulfate-reducing enrichment culture. In one embodiment, the biodegrading and sulfate-reducing enrichment culture comprises at least 0.1% of the total volume in the biochemical reactor. In one embodiment, the biodegrading and sulfate-reducing enrichment culture comprises at least 0.15% of the total volume in the biochemical reactor. In one embodiment, the biodegrading and sulfate-reducing enrichment culture comprises between at least 0.15% and 0.4% of the total volume in the biochemical reactor. In one embodiment, the biodegrading and sulfate-reducing enrichment culture comprises at least 1% of the total volume in the biochemical reactor.

Advantageously, the sulfate-reducing biochemical reactor stage in the disclosure may reduce the concentration of sulfate found in contaminated fluid influent. The process is designed to force the formation, precipitation, and removal of metal sulfides. Any suitable sulfate-reducing bacteria may be employed in the biochemical reactor. Many species and strains of such bacteria are ubiquitous to soil and water environments and known to those skilled in the art. Thus, a sulfate-reducing biochemical reactor may contain a diverse anaerobic microbial community including multiple types of sulfate-reducing bacteria, fermenters, and hydrolytic bacteria, for example. The microbial composition implemented in the sulfate-reducing bacteria reactor may comprise. but is not limited to, Desulfobacterota, Negativicutes, Anaerovibrio, Anaeroineaceae, Leptolinea, Bacillota, Bacteroidota, Synergistaceae, Comamonadaceae, Megasphaera, Pelosinus, Selenomonas, Propionispira arcuate, Pectinatus, Acidaminococcus, Clostridia, FCPU426, Gastranaerophilales, Cyanobacteria, Chloroflexia, Caldisericales, Bacteriodales, Corynebacterium, Acetothermiia bipolaricaulis, other Archaea, Methanosaeta, Methanomicrobiales, and/or Bathyarchaeia.

In one embodiment, the biochemical reactor comprises an outlet to direct excess biogas into a vessel. The vessel may comprise basic media that serves to neutralize excess biogas. In one embodiment, the basic media comprises a solution of sodium hydroxide. In one embodiment, the basic media comprises a solution of potassium hydroxide. In one embodiment, the basic media comprises a solution of magnesium hydroxide. In one embodiment, the basic media comprises calcium carbonate. In one embodiment, the basic media comprises a basic salt including, but not limited to, calcium carbonate, sodium carbonate, sodium acetate, potassium acetate, sodium fluoride, sodium hypochlorite, sodium citrate, sodium sulfide, and potassium cyanide.

The reactors and biochemical reactors described herein may comprise any suitable hollow vessel appropriate for transportation of fluid. In one embodiment, the reactors and biochemical reactors are columns. In one embodiment, the reactors and biochemical reactors are pipes. In one embodiment, the reactors and biochemical reactors are tanks. In one embodiment, the reactors and biochemical reactors are dugouts. In one embodiment, the reactors and biochemical reactors are manifolds. In one embodiment, the reactors and biochemical reactors are reservoirs. In one embodiment, the reactors and biochemical reactors are barrels. In one embodiment, the reactors and biochemical reactors are containers.

Suitable material for the reactors and biochemical reactors may comprise any material known in the art including but not limited to organic polymers, inorganic polymers, homopolymers, copolymers, thermoplastics, thermosets, glass, quartz, ceramic, silica, alloy, metal alloy, stainless-steel, stainless-steel alloy, aluminum, aluminum alloy, aluminum oxide, copper, copper, alloy, titanium, titanium alloy, brass, plastic, or any combination thereof. Exemplary plastics include, but are not limited to, polyolefins, polyethylene, high-modulus polyethylene (HMPE), polypropylene, polybutylene, polybutene, polybutadiene, polybutylene terephthalate (PBT), polyethylene terephthalate (PET), 30 polytetrafluoroethylene (PTFE), polyvinylidene fluoride (PVDF), polycyclopentadiene (PCP), hydrogenated polycyclopentadiene (HCPC), polyetherimide (PEEK), polystyrene (PS), polyurethane (PU), polycarbonate (PC), polyacrylate, polymethacrylate, poly(methyl)methacrylate, polyoxymethylene, polylactic acid, polyether ether ketone, polyvinyl ether, polyvinyl chloride (PVC), chlorinated polyvinyl chloride, acrylonitrile butadiene styrene (ABS), polyethylene vinyl acetate (PEVA), styrene-butadiene copolymer, fluorinated polymer, and combinations thereof. In some embodiments, the material may be the same throughout the reactors and biochemical reactors, or the material may be varied to accommodate various specifications, such as transparency for monitoring or to meet requirements for the fluid to move slowly and/or quickly.

In one embodiment, the reactors and biochemical reactors described herein comprise valves to control fluid levels. In one embodiment, the valves are drain valves. In one embodiment the valves are venting valves. In one embodiment, the valves are shut-off valves. In one embodiment, the valves are transfer valves. In one embodiment, the valves are pressure relief valves. The valves may comprise any type of valve known in the art which include, but are not limited to, tee valves, ball valves, butterfly valves, diaphragm valves, gate valves, pinch valves, piston valves, plug valves, globe valves, needle valves, swing check valves, multi-port valves, float valves, foot valves, knife gate valves.

The reactor and biochemical reactor may comprise a drainage layer. The drainage layer may comprise at least 1% of the total volume of the reactor. In one embodiment, the drainage layer comprises between 2% and 10% of the total volume of the reactor and biochemical reactor. In one embodiment, the drainage comprises 8.6% total volume of the reactor and biochemical reactor. In one embodiment, the drainage layer comprises at least 25% of the total volume of the reactor and biochemical reactor. Suitable material for the drainage layer may comprise any material known in the art including, but not limited to, charcoal, concrete, glass, perlite, vermiculite, sand, clay, gravel, pea gravel, river rock, quartz sand crushed stone, and plastic beads. In one embodiment the drainage layer is a filter disc. In one embodiment, the drainage layer is a mesh filter. In one embodiment, the drainage layer is a grid filter. In one embodiment, the drainage layer is a cotton filter. In one embodiment, the drainage layer is stainless steel filter.

In various embodiments, the reactor and biochemical reactor have a circular, rectangular, triangular, elliptical, or rectilinear cross-section. In one embodiment, the reactor and biochemical reactor have a uniform cross-section area. In one embodiment, the cross-sectional area is substantially the same along the lengths of the reactor and biochemical reactor. In one embodiment, the reactor and biochemical reactor have a non-uniform cross-section area. In one embodiment, the cross-sectional area is not the same along the length of the reactors and biochemical reactors. In various embodiments, the reactor and biochemical reactor have circular cross-sections diameters in the range of 10 mm to 1,000 mm. In one embodiment, the reactor and biochemical reactor have a circular cross-section with diameters in the range of 50 to 250 mm. In one embodiment, the reactor and biochemical reactor have circular cross-sections with diameters of at least 100 mm.

In various embodiments, the reactor and biochemical reactor have lengths in the range of 10 cm to 10 m. In one embodiment, the reactor and biochemical reactor have lengths between 10 cm and 5 m. In one embodiment, the reactor and biochemical reactor have lengths between 10 cm and 3 m. In one embodiment, the reactor and biochemical reactor have lengths between 10 cm and 2 m. In one embodiment, the reactor and biochemical reactor have lengths of at least 10 cm. In one embodiment, the reactors have lengths of at least 100 cm. In one embodiment, the reactor and biochemical reactor have lengths of at least 10 m.

In one embodiment, a pump may be employed to drive contaminated fluid influent through all or parts of the system. In one embodiment, the system comprises a centrifugal pump. In one embodiment, the system comprises a submersible pump. In one embodiment, the system comprises a positive displacement pump. In one embodiment, the pump is a screw pump. In one embodiment, the pump is a reciprocating pump. In one embodiment, the pump is a radial piston pump. In one embodiment, the pump is a hydraulic pump. In one embodiment, the pump is a rotary vane pump. In one embodiment, the pump is a piston pump. In one embodiment, the pump is an axial flow pump. In one embodiment, the pump is a gear pump. In one embodiment, the pump is a plunger pump. In one embodiment, the pump is a dynamic pump. In one embodiment, the pump is a diaphragm pump. In one embodiment, the pump is a lobe pump. In one embodiment, the pump is a gear pump. In one embodiment, the pump is a metering pump. In one embodiment, the pump is a vacuum pump. In one embodiment, the pump is a peristaltic pump. In one embodiment the reactors comprise a power source that can be used to operate the pumps and monitoring equipment in order to operate the system and vessels discussed herein. In one embodiment, a pump is not required and flow of fluid is based on gravity.

### Method of MIW Purification

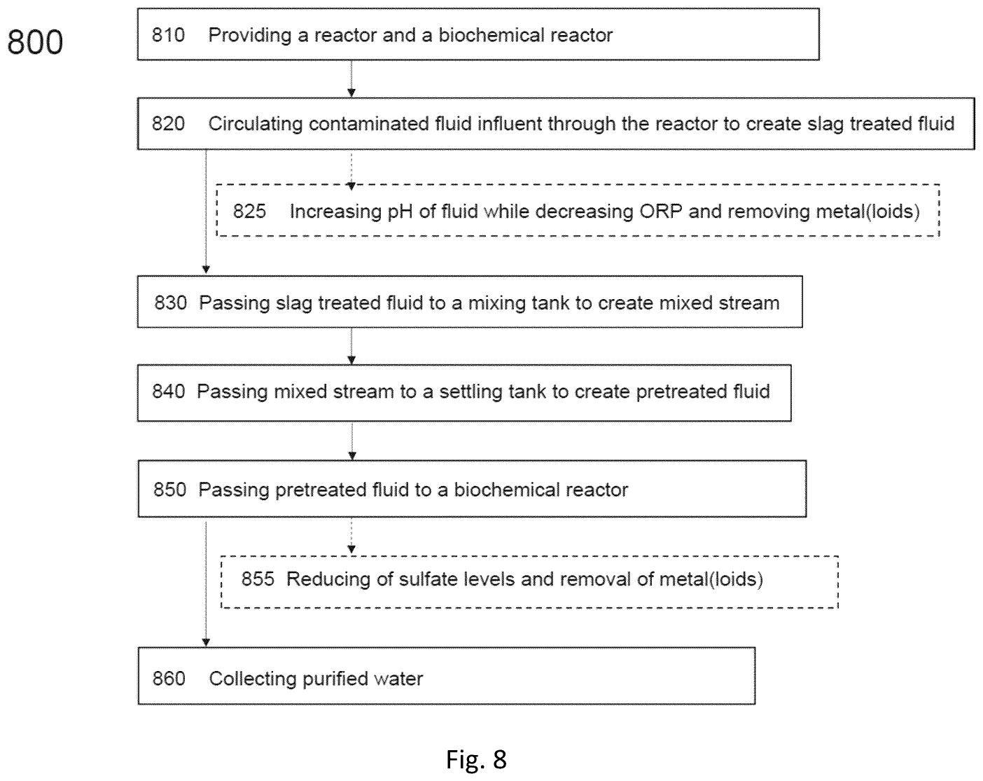

In one aspect, the present invention relates in part to a method of purifying contaminated fluid influent. Exemplary method 800 is provided in FIG. 8. In step 810, a reactor and a biochemical reactor are provided. In step 820, contaminated fluid influent is circulated through the reactor to create a slag treated fluid. In step 825, pH of the contaminated fluid influent increases, the ORP decreases, dissolved oxygen concentration decreases, and metal(loids) are removed. In one embodiment, the slag treated fluid has a pH of at least 4. In step 830, the slag-treated fluid is passed to a mixing tank to create a mixed stream. In step 840, the mixed stream is passed to a settling tank to create a pretreated fluid. In step 850, the pretreated fluid is passed through at least one biochemical reactor. In step 855, sulfate levels are reduced, and metal(loids) are removed from the contaminated fluid influent. In step 860, purified water is collected.

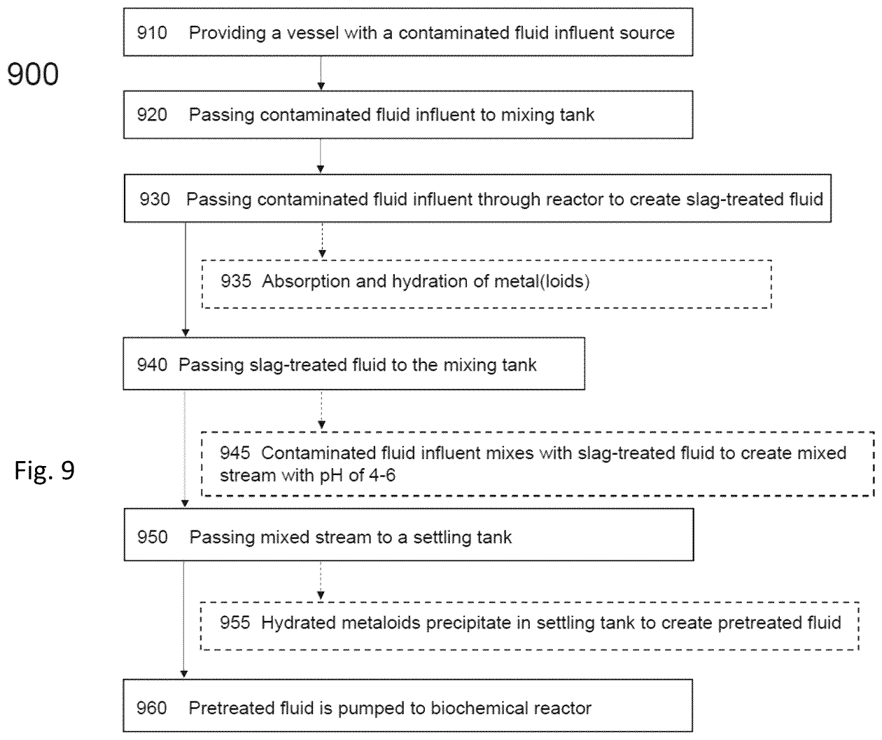

Exemplary method 900 is provided in FIG. 9. FIG. 9 provides further detail into steps which comprise the reactor. In step 910, a contaminated fluid influent source is provided. In step 920, contaminated fluid influent is passed to the mixing tank. In step 930, contaminated fluid influent is passed through the reactor. In step 935, the reactor precipitates and/or adsorbs metal(loids), and increases pH of the contaminated fluid influent. In step 940, the slag-treated fluid is passed to a mixing tank. In step 945, contaminated fluid influent mixes with the slag-treated fluid in the mixing tank to create a mixed stream and the pH of the mixed stream reaches 4-6. In step 950, the mixed stream is passed to the settling tank. In step 955, precipitated metal(loids) settle in the settling tank to create pretreated fluid. In one embodiment, the pretreated fluid comprises less metal(loids) than the mixed stream. In step 960, pretreated fluid is passed to and through the biochemical reactor.

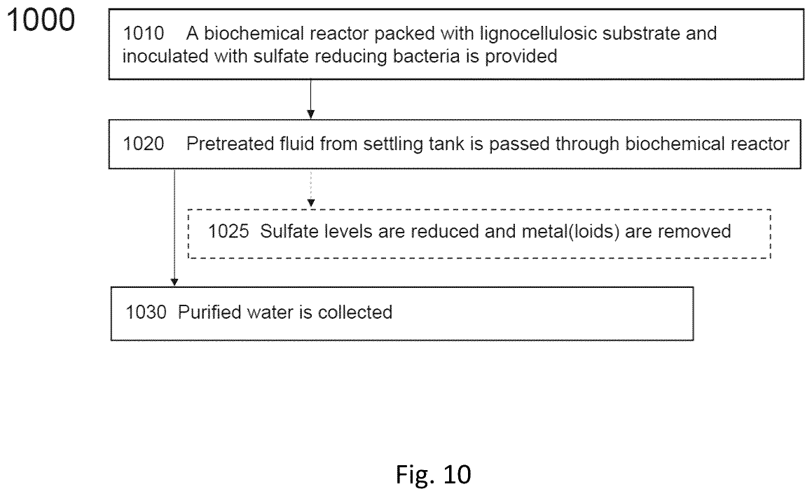

Exemplary method 1000 is provided in FIG. 10. FIG. 10 provides further detail into steps which comprise the biochemical reactor. In step 1010, a biochemical reactor packed with lignocellulosic substrate and inoculated with sulfate-reducing microbial community is provided. In step 1020, pretreated fluid from settling tank is passed through the biochemical reactor. In step 1025, sulfate levels are reduced and metal(loids) are removed. In step 1030, purified water is collected.

In one embodiment, the reactor comprises a reactor inlet, a reactor outlet, and a purification composition. In one embodiment, the purification composition comprises slag and a dispersing component. The slag and dispersing component may comprise any type of slag and dispersing component described elsewhere herein.

In one embodiment, the biochemical reactor comprises a biochemical reactor inlet, biochemical reactor outlet and a purification media. In one embodiment, the purification media comprises a lignocellulosic component and sulfate reducing bacteria.

The process may be operated in any manner desired, e.g. as continuous, semi-continuous. The process may be controlled using known equipment and control schemes. For example, hydraulic retention time, desired feed rates of input water, nutrients, etc. may be determined by routine experimentation. In one embodiment, the flow rate in the process is controlled by setting a pump to the desired flow rate. In one embodiment, the flow rate through part or all of the system is at least 0.1 L d⁻¹. In one embodiment, the flow rate through part or all of the system is at least 0.2 L d⁻¹. In one embodiment, the flow rate through part or all of the system is between at least 0.3 L d⁻¹ and 1.0 L d⁻¹. In one embodiment, the flow rate through part or all of the system is between at least 2.0 L d⁻¹. In one embodiment, the flow rate through part or all of the system is between at least 10.0 L d⁻¹. Full-scale systems would be operated at high flow rates, such as gallons per minute or equivalent flow rates.

The step of circulating the contaminated fluid influent through the reactor comprises increasing the pH of the contaminated fluid influent. In one embodiment, the pH of the contaminated fluid influent increases to at least 4. In one embodiment, the pH of the contaminated fluid influent increases to at least 5. In one embodiment, the pH of the contaminated fluid influent increases to at least 6. In one embodiment, the pH of the contaminated fluid influent increases to at least 7. In one embodiment, the pH of the contaminated fluid influent increases to at least 8. In one embodiment, the pH of the contaminated fluid reaches between 4 and 6. In one embodiment, the pH of the contaminated fluid influent increases to at least 13. In one embodiment, the pH of the contaminated fluid influent decreases when it reaches the mixing tank. Mixing the slag treated fluid with contaminated fluid influent brings the pH of the fluid in the mixing tank to an optimal level in order to optimize microbial activity and metal(loid) precipitation in the sulfate-reducing biochemical reactor stage.

The method described finds use for remediation of fluid contaminated with metals or metalloids. Metal or metalloid contaminants may comprise, but are not limited to aluminum, iron, manganese, nickel, magnesium, lead, chromium, arsenic, cobalt, zinc, copper, cadmium, silver, vanadium, nickel, mercury, uranium, barium, selenium, strontium, plutonium, thorium, technetium, thallium, beryllium, and any metal that either has an affinity for sulfur, carbonate, hydroxides, or that can exist in multiple oxidation states.

In one embodiment, the step of circulating the contaminated fluid influent through the reactor, comprising pumping the mixed stream from the mixing tank through the reactor inlet, out the reactor outlet and into the mixing tank, is in a partial recycle loop. In one embodiment, the mixing tank is stirred. In one embodiment, the mixing tank is stirred at an RPM of at least 10. In one embodiment, the mixing tank is stirred at an RPM of at least 50. In one embodiment, the mixing tank is stirred at an RPM of at least 250. In one embodiment, the mixing tank is stirred at an RPM between 100 and 500. In one embodiment, the mixing tank is stirred at an RPM of at least 1000. In one embodiment, the mixing tank is stirred at an RPM of at least 250.

In one embodiment, the step of circulating the contaminated fluid influent through the reactor further comprises the step of precipitation and/or adsorption of metal(loid)s. In one embodiment, the step of passing the slag-treated fluid to the settling tank is done with a pump. In one embodiment, the step of pumping the slag treated fluid to the settling tank further comprises the step of precipitating the metal(loid)s in the settling tank, thus reducing metal(loid) levels before reaching the biochemical reactor.

In one embodiment, the step of passing the pretreated fluid through the biochemical reactor, further comprises the step passing the pretreated fluid through a lignocellulosic substrate. The biochemical reactor may comprise lignocellulosic components which develop distinct microbial communities enriched in sulfate-reducing, fermentative and hydrolytic taxa.

In one embodiment, the step of providing a biochemical reactor further comprises the step of introducing bacteria to biochemical reactor and growing the bacteria in the biochemical reactor. In one embodiment, the step of providing a biochemical reactor further comprises the step of introducing a lignocellulosic component and inoculating the lignocellulosic component with an anaerobic digestor sludge. In some embodiments, the lignocellulosic components are inoculated with waste activated sludge. In one embodiment, the lignocellulosic components are inoculated with sediments or soils. In one embodiment, the lignocellulosic components are inoculated with soils or sediments contaminated by mining-influenced water. In some embodiments the lignocellulosic components are inoculated with animal manure, such as sheep or cattle manure. In one embodiment, the inoculant comprises at least 0.5% of the total volume in the biochemical reactor. In one embodiment, the anaerobic digestor sludge comprises at least 1.3% of the total volume in the biochemical reactor.

In one embodiment, the biochemical rector comprises a biodegrading and sulfate-reducing enrichment culture. In one embodiment, the biodegrading and sulfate-reducing enrichment culture comprises at least 0.1% of the total volume in the biochemical reactor. In one embodiment, the biodegrading and sulfate-reducing enrichment culture comprises at least 0.15% of the total volume in the biochemical reactor. In one embodiment, the biodegrading and sulfate-reducing enrichment culture comprises between at least 0.15% and 0.4% of the total volume in the biochemical reactor. In one embodiment, the biodegrading and sulfate-reducing enrichment culture comprises at least 1% of the total volume in the biochemical reactor.

Advantageously, the sulfate-reducing biochemical reactor stage in the disclosure may reduce the concentration of sulfate found in contaminated fluid influent. The process is designed to force the formation, precipitation, and removal of metal sulfides. Any suitable sulfate-reducing bacteria may be employed in the biochemical reactor. Many species and strains of such bacteria are ubiquitous to mining influenced water environments and known to those skilled in the art. Thus, a biochemical reactor may contain a diverse anaerobic microbial community including multiple types of sulfate-reducing bacteria, fermenters, and hydrolytic bacteria, for example. The microbial composition implemented in the biochemical reactor may comprise, but is not limited to, Desulfobacterota, Negativicutes, Anaerovibrio, Anaeroineaceae, Leptolinea, Bacillota, Bacteroidota, Synergistaceae, Comamonadaceae, Megasphaera, Pelosinus, Selenomonas, Propionispira arcuate, Pectinatus, Acidaminococcus, Clostridia, FCPU426, Gastranaerophilales, Cyanobacteria, Chloroflexia, Caldisericales, Bacteriodales, Corynebacterium, Acetothermiia bipolaricaulis, other Archaea, Methanosaeta, Methanomicrobiales, and/or Bathyarchaeia.

Contaminated fluid influent treatment in the sulfate-reducing biochemical reactor stage relies on fermentative and hydrolytic bacterial ability to break down the lignocellulosic components to electron donors (e.g., H₂, organic acids, alcohols) for sulfate-reduction. In one embodiment, the biochemical reactor comprises an external source of electron donor. Examples of electron donors may comprise, but are not limited to, ammonia, ammonium, carbon monoxide, dithionite, elemental sulfur, hydrocarbons, hydrogen, metabisulfites, nitric oxide, nitrites, sulfates, thiosulfates, sulfides, hydrogen sulfide, sulfites, thionate, thionite, transition metals, oxides, chalcogenides, halides, hydroxides, oxyhydroxides, phosphates, sulfates, or carbonates, vegetable oil, ethanol, methanol, lactic acid, acetic acid, sodium lactate, sodium acetate, glycerol, sugars, molasses, photosynthetic and non-photosynthetic microbes, pigments, and ethyl lactate. In one embodiment, the amount of electron donor is determined by the input water flow rate and the amount of sulfate reduction desired. Mixtures of electron donors may be employed.

Sulfate-reducing bacteria pertinent to mining influent water treatment require a pH above 4. In some embodiments, the biochemical reactor is packed with a mixture of lignocellulosic material and alkalizing agent in order to provide an additional source of alkalinity. In one embodiment, the alkalizing agent comprises limestone. In one embodiment, the alkalizing agent comprises dolomite. In one embodiment, the alkalizing agent comprises fly ash. In one embodiment, the alkalizing agent comprises between 10-80% of the total weight in the biochemical reactor.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

### Example 1: High Efficacy Two-Stage Metal Treatment Incorporating Basic Oxygen Furnace Slag and Microbiological Sulfate Reduction

Lignocellulosic sulfate-reducing biochemical reactors (SRBRs) are a passive treatment technology that can be implemented at mining sites to mitigate the potentially deleterious effects of mining-influenced water (MIW)—typically acidic with high concentrations of sulfate and metal(loid)s. pH management is critical in MIW treatment by SRBRs as it controls microbial SO₄²⁻ reduction and metal(loid) immobilization. Identifying novel, effective alkalizing materials to help manage MIW pH for metal(loid) treatment and SRBR longevity is essential. In this study, basic oxygen furnace slag, a powerful alkalizing by-product from the steel industry, and SRBRs (containing spent brewing grains or sugarcane bagasse) were incorporated into a two-stage treatment for MIW.

Basic oxygen furnace slag, a type of steel slag, is created when molten iron ores are blasted with oxygen gas (O₂) and then combined with lime or dolomite to remove impurities. The generated liquid steel sinks to the bottom of the furnace, while the lime or dolomite combined with impurities float to the top. Steel slags are porous and composed of crystal lattices which include metal oxides of calcium, magnesium, iron, and silicon. Slag leachate has significantly more alkalinity than limestone leachate 500-2000 mg L⁻¹ CaCO₃ equivalents in steel slag vs. 60-80 mg L⁻¹ in limestone. Slag has been reported to efficiently remove Al, beryllium, Cd, Cu, Fe, Ni, Pb, thallium, and Zn through precipitation, as oxides and hydroxides, and adsorption. When calcium oxide (CaO) and other oxides in slag are hydrated (Eq. 1), hydroxide ions (OH⁻) are produced (Eq. 2). Released OH⁻ increase MIW pH and precipitates MIW metal(loid)s as shown in Eq. 3, where M is a metal(loid), x is the metal(loid) charge (e.g., 2 or 3) and the stoichiometric coefficient of OH⁻.

CaO+H₂O→Ca(OH)₂ (1)

Ca(OH)₂→Ca²⁺+2OH⁻ (2)

M^{x+}+xOH⁻→M(OH)ₓ (3)

While the potential of slag for chemical treatment of MIW has been clearly demonstrated, research combining slag with microbial processes, such as denitrification, fermentation, and sulfate-reduction has only recently emerged.

The two-stage design was used to assess MIW treatment effectiveness while (i) quantitatively defining the specific contributions of slag and SRBRs metal(loid) removal from MIW and (ii) tracking the effects of slag stage on the SRBR microbial activity, community composition, and extent of lignocellulose biodegradation. The substantial metal(loid) removal from MIW achieved by the two-stage treatment from this study underscores the potential for slag and lignocellulosic SRBRs containing spent brewing grains or sugarcane bagasse for implementation at the field-scale.

In this two-stage treatment, the slag stage increased MIW pH from 2.6±0.2 to 5.0±1.0 and reduced overall total metal(loid) concentrations entering the SRBRs from 72-173 mg L⁻¹ to 12-135 mg L⁻¹ due to the slag reactor's capacity to increase MIW pH to 12 and remove >99.9% of total metal(loid)s. The SRBR stage removed the bulk of sulfate from MIW and additional metals, but preferentially removed sulfide-precipitate forming metals such as cadmium, copper, and zinc to >96% removal. Combined, the two-stage treatment removed 92±15-94±7% of total metal(loid) concentrations. The SRBRs receiving MIW from the slag stage developed distinct microbial communities enriched in sulfate-reducing, fermentative and hydrolytic taxa. Overall, this study underscores the potential of a two-stage treatment employing slag and SRBRs for full-scale implementation at mining sites.

### Materials and Preparation of Synthetic MIW

The basic oxygen furnace slag used in this study was provided by Phoenix Services LLC, Indiana-Burns Harbor, Indiana, USA. The slag was sieved, and the resulting slag contained particles in the 9-20 mm diameter range. Spent brewing grains and sugarcane bagasse were used as lignocellulosic substrates in this study because of their documented potential in stimulating sulfate reduction in SRBRs. Spent brewing grains (after the mashing process) were obtained from SanTan Brewery in Chandler, Arizona, USA, and were transported to Arizona State University the same day. Sugarcane bagasse was provided by Cajun Sugar Company in New Iberia, Louisiana, USA. The lignocellulosic materials were stored at 4° C. in airtight plastic containers until they were used to pack the SRBRs. Pertinent properties of the spent brewing grains and sugarcane bagasse can be found in Table 1.

Synthetic MIW (referred henceforth as MIW) was prepared with the following composition per liter: 50 mg Al₂(SO₄)₃·H₂O, 0.18 mg NaAsO₂, 0.01 mg BaSO₄, 0.30 mg CdSO₄, 330 mg CaCl₂)·2H₂O, 0.01 mg K₂CrO₄, 0.07 mg CoCl₂·6H₂O, 1.8 mg CuCl₂·5H₂O, 290 mg Fe₂(SO₄)₃·H₂O, 100 mg Fe(SO₄)·H₂O, 0.15 mg PbCl₂, 160 mg MgCl₂·6H₂O, 300 mg MnCl₂·4H₂O, 0.04 mg NiSO₄, 1.1 mg K₂HPO₄, 0.7 mg KCl, 0.2 μg AgNO₃, 0.06 mg VCl₃, 380 mg NH₄Cl, 175 mg ZnCl₂, 63 mg Na₂SO₄, and 0.16 mL H₂SO₄. The final pH was 2.5 and the total sulfate (SO₄²⁻) concentration was 6.5 mM (650 mg L⁻¹).

TABLE 1
Measured parameters of the lignocellulosic material used to pack
SRBRs. The pH, total dissolved solids, and conductivity measurements
were obtained from 20 g spent brewing grains + 25 mL DI
water or 10 g sugarcane bagasse + 45 mL DI water. The data
are averages with standard deviations of triplicate samples.

| | Spent brewing | |
|---|---|---|
| Parameter | grains | Sugarcane bagasse |
| Moisture (%) | 75.0 ± 0.7 | 60 ± 2 |
| Density (kg L⁻¹) | 1.1 | 0.68 |
| Total organic | (4.8 ± 0.2) × 10⁵ | (4.47 ± 0.05) × 10⁵ |
| carbon (TOC) | | |
| (mg kg⁻¹) | | |
| pH (s.u.) | 4.09 ± 0.01 | 6.44 ± 0.03 |
| Total dissolved | 260 ± 3 | 160 ± 4 |
| solids (ppm) | | |
| Conductivity | 580 ± 5 | 350 ± 5 |
| (μS cm⁻¹) | | |
| Sulfate (mg kg⁻¹) | 36 ± 3 | 19 ± 2 |

### Design and Operation of a Two-Stage Slag and SRBR Treatment

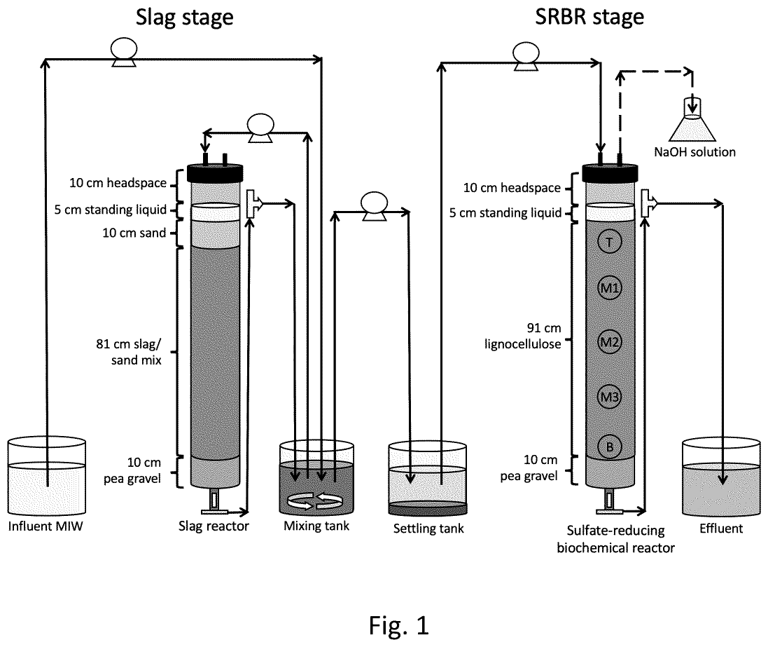

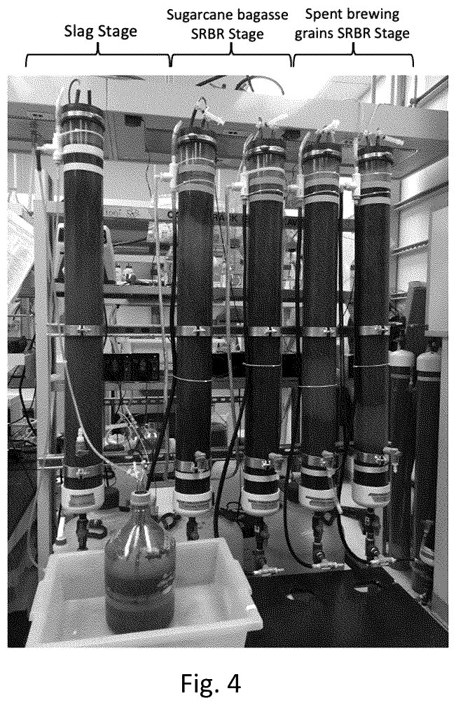

The schematic of the two-stage treatment from this study is shown in FIG. 1. An image of the system is shown in FIG. 4. The components of the slag stage were a slag reactor, a settling tank, and a mixing tank. The SRBR stage consisted of two sets of SRBRs packed with either spent brewing grains or sugarcane bagasse. The slag reactor and SRBRs were constructed from clear, schedule 40 PVC pipes (L=116 cm, ID=10 cm, V=9.1 L) and were mounted using strut channel clamps to a shelf. SRBRs had outflow PVC clear flexible tubing connected to a three-way tee placed 10 cm below the top and 5 cm above the packed material to control water levels. A remaining port guided the effluent of each reactor to its next destination through PVC flexible tubing while another port remained open to the atmosphere to maintain 5 cm of standing liquid in the reactors. Liquid from the settling tank (end of the slag stage) was then pumped in the SRBRs.

### Slag Stage

The slag reactor contained 10 cm thick drainage layer of pea gravel at the bottom (Vigro, Illinois, USA), 81 cm of a homogenous mixture of 70% Ottawa 20-30 silica sand (U.S. Silica, Ottawa, Illinois, USA) and 30% slag (basic oxygen furnace slag), and a top layer of 10 cm of Ottawa 20-30 silica sand. Once packed, the slag reactor was filled with MIW from bottom to top to achieve material saturation. Peristaltic pumps (Masterflex C/L Dual Channel, Cole-Parmer, Vernon Hills, Illinois, USA) were used to flow synthetic MIW into a 5-L mixing tank at 2.9 L d⁻¹. The mixing tank was stirred at 250 rpm on a stir plate (Thermo Fisher Scientific, Waltham, Massachusetts, USA). The liquid from the mixing tank flowed at the same flow rate (2.9 L d⁻¹) into a settling tank where metal(loid) precipitates settled. The slag reactor was in a recycle loop (˜20% recycle capacity per day) with the mixing tank, where liquid from the mixing tank flowed to the top of the slag reactor and back into the mixing tank at a recycle flow rate of 0.6 L d⁻¹.

### Sulfate-Reducing Biochemical Reactor (SRBR) Stage

Duplicate SRBRs were packed with pea gravel (Vigoro, 10 cm bottom layer) and either spent brewing grains or sugarcane bagasse (91 cm layer) (FIG. 1). The lignocellulosic substrate was added to the SRBRs with their respective “as arrived” moisture content (Table 1). Because the lignocellulosic substrate had different densities (Table 1), the total material added in the spent brewing grains and sugarcane bagasse SRBRs varied. Specifically, each SRBR was packed with either 3.5 kg of spent brewing grains (2.6 kg dry weight) or 1.45 kg of sugarcane bagasse (0.87 kg dry weight). The SRBRs were filled from bottom to top with MIW from the settling tank until there was a 5-cm standing liquid above the lignocellulosic substrate (FIG. 1). The SRBRs were inoculated with 125 mL of anaerobic digestor sludge from the Mesa Northwest Water Reclamation Plant, Mesa, Arizona, USA and 25 mL of spent brewing grains or sugarcane bagasse biodegrading and sulfate-reducing enrichment culture. The enrichment process and the microbial community compositions of these cultures were reported in a previous study.

Water from the settling tank entered the SRBRs at the top. The SRBRs were operated directly in continuous mode (no batch operation) as previously described. The flow rate for the spent brewing grains SRBRs during the acclimation period was 0.6 L d⁻¹ (corresponding to an HRT of 8 d). On day 38, the operational phase commenced at flow rate of 1.1 L d⁻¹ (4.6-day HRT) and 13.5 HRTs were completed until the end of the experiment (day 121). The flow rate for the sugarcane bagasse SRBRs during acclimation was 1.1 L d⁻¹ (7.3-day HRT) for the first 35 days. Then, for the operational phase, the flow rate was increased to 1.8 L d⁻¹ (3.3-day HRT) for a total of 19.7 HRTs until the end of the experiment (day 121). The slag and SRBRs treatment train was frequently sampled during operation.

### Chemical and Microbiological Analyses

pH, oxidation reduction potential (ORP), dissolved oxygen (DO), conductivity and total dissolved solids were measured using a Thermo Fischer Scientific Orion Versa Star Pro benchtop multipurpose meter fitted with a ROSS Ultra pH/ATC Triode Refillable Electrode (Thermo Fischer Scientific, Chelmsford, Massachusetts, USA) and an RDO Optical Dissolved Oxygen Sensor. The instrument probes were calibrated according to the manufacturer's instructions. Spent brewing grains and sugarcane bagasse total organic carbon was measured by a Lotix Total Organic Carbon analyzer with a Lotix Solids Sampler Boat Module (Teledyne Tekmar, Mason, Ohio, USA) using a method previously reported.

SO₄²⁻ concentrations were measured using an ion chromatograph (IC) (Metrohm 930 Compact Flex, Riverview, Florida, USA) equipped with a Metrosep A Supp 5-150/4.0 column. The method oven temperature was constant at 30° C. The eluent was 3.2 mM Na₂CO₃ and 1 mM NaHCO₃ and the eluent flow rate was 0.7 mL min-. The calibration range was 0.1-100 mg L⁻¹ SO₄²⁻ and the minimum detection limit for SO₄²⁻ was 0.03 mg L⁻¹. Before IC analysis, the influent and effluent samples were diluted 1 in 10 using deionized water (≥18 mΩ) and filtered using a 0.2 μm polyvinylidene difluoride membrane filter (PVDF, MDI Membrane Technologies, Ambala Cantt, India). SO₄²⁻ concentrations in the lignocellulosic substrates were prepared by mixing 1 g of material with 10-20 mL of deionized water (≥18 mΩ) in triplicates and filtering through a 0.2 μm PVDF membrane. The concentration of total dissolved sulfide (S²⁻) was measured using a HACH color test kit (Loveland, CO, USA) according to the manufacturer's protocol. The detection range of the kit which was 0.4-10 mg L⁻¹ S²⁻.

The concentrations of silver (Ag), Al, As, barium, Cd, chromium, cobalt, Cu, Fe, Mg, Mn, Ni, Pb, vanadium, and Zn were analyzed by inductively coupled plasma-optical emission spectroscopy (ICP-OES) by the Metals and Environmental and Terrestrial Analytical Laboratory, Chemical and Environmental Characterization Facility, Arizona State University. Liquid samples (10 mL) were centrifuged for 15 min at 4000 rpm, filtered through a 0.2 μm PVDF membrane filter (MDI Membrane Technologies), and diluted 1 in 10 with deionized water (≥18 mΩ). Concentrated HNO₃ was used to acidify each sample to pH<2. The detection limit of the measured metal(loid)s by ICP-OES was 0.4-9.4 μg L⁻¹.

Concentrations of fermentation products (formic acid, acetic acid, ethanol, propionic acid, lactic acid, butyric acid, valeric acid, and caproic acid) were measured with a Shimadzu High-Performance Liquid Chromatograph (HPLC, LC-20AT, Columbia, MD, USA) from 1 mL of liquid samples filtered through a 0.2 μm PVDF membrane filter. The methodology for this analysis was described in detail previously and microbiological trichloroethene and perchlorate reductions are determined by the concentration and speciation of Fe. The calibration curve for organic acids and alcohols was 1-10 mM. Detection limits of the analytes ranged from 0.9-7 mg L⁻¹.

The composition of cellulose, hemicellulose, and lignin in the spent brewing grains and sugarcane bagasse was determined using an Ankom Technology A2000 fiber analyzer (Macedon, New York, USA). Analysis was performed on triplicate samples of 10-20 g of spent brewing grains and sugarcane bagasse before use in SRBRs (on day 0) and at the end of SRBR operation (on day 121) at locations T, M1, M2, M3, and B locations (FIG. 1). The lignocellulosic samples were first rinsed with deionized water (≥18 mΩ) to remove precipitates. They were then dried overnight at 105° C. and manually ground. Hemicellulose, cellulose, and lignin composition was determined using the recommended protocols by Ankom Technology.

Genomic DNA for amplicon sequencing was extracted using a DNeasy PowerFood Microbial Kit (QIAGEN, Germantown, Maryland, USA). DNA was extracted from 1.8 mL of liquid sample taken from the anaerobic digester sludge (ADS) and from each lignocellulose material enrichment culture. DNA was also extracted from 0.2 g of sample taken from the original spent brewing grains, the original sugarcane bagasse, and each duplicate SRBR post operation from locations T, M2, and B (FIG. 1). Prior to amplicon sequencing, nucleotide yield and purity were determined using a Nanodrop 1000 spectrophotometer (Thermo Scientific, Waltham, Massachusetts, USA). Amplicon sequencing was performed at the Center for Fundamental and Applied Microbiomics at the ASU KED Genomics Core Facility, Arizona State University, Tempe, Arizona using a MiSeq instrument (Illumina Inc., San Diego, California, USA). The V4 hyper-variable region of the 16S rRNA gene for Bacteria and Archaea was targeted using the original Earth Microbiome Project primers 515F (5′-GTGCCAGCMGCCGCGGTAA-3′ (SEQ ID NO:1)) and 806 R (5′-GGACTACHVGGGTWTCTAAT-3′ (SEQ ID NO:2)).

CASAVA 1.8 paired-end demultiplexed sequences were imported into Quantitative Insights into Microbial Ecology (QIIME 2, v. 2020.8.0). The sequences were truncated to 250 base pairs for quality control and then denoised using the DADA2 pipeline. Taxonomy was assigned to the amplicon sequence variants (ASVs) by referencing the SILVA database (v.138). Bray-Curtis diversity analyses, Faith's phylogenetic diversity indices, and Pielou's evenness indices were generated via the q2-diversity plugin core-metrics-phylogenetic method. For these analyses, the sampling depth was 3872, the lowest sequence number in the samples from this study. The raw sequences were deposited in the National Center for Biotechnology (NCBI) Sequence Read Archive (SRA) under project number PRJNA699925 with accession numbers SAMN17816982-SAMN17816998.

The Slag Stage Provided Significant Metal(Loid) Removal from MIW while Also Increasing pH and Decreasing ORP

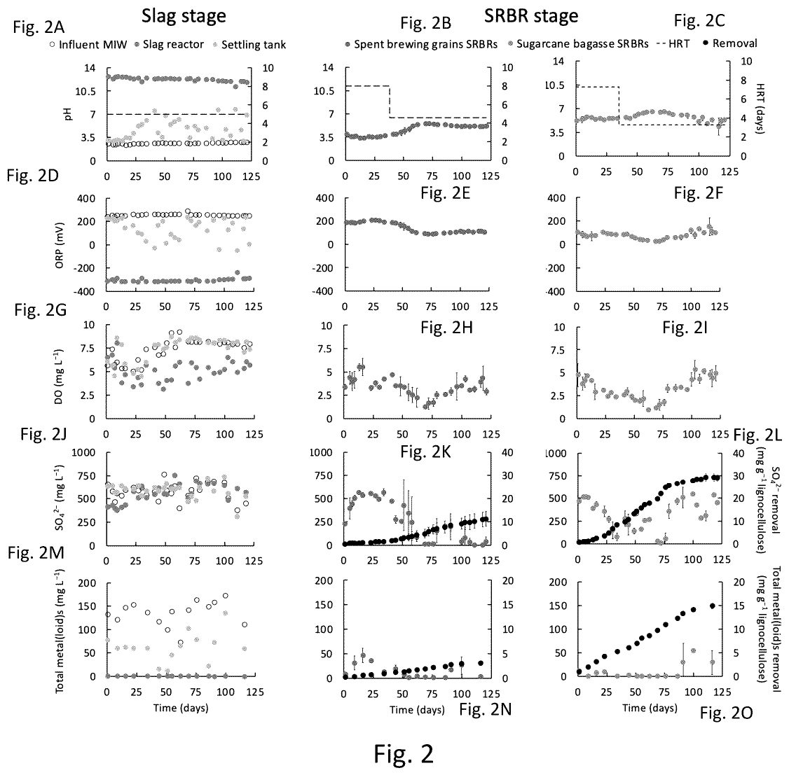

In the novel two-stage treatment process evaluated in this study, a slag reactor, mixing tank, and a settling tank made up the slag stage (FIG. 1). The mixing tank received fresh MIW, was in recirculation with the slag reactor, and fed a settling tank. The SRBR stage received pre-treated MIW from the slag stage and was composed of two sets of lignocellulosic SRBRs (in parallel) packed with either spent brewing grains or sugarcane bagasse. FIG. 2 compiles the measurements during 121 days of operation at the slag and SRBR stages of treatment. The most notable effects on MIW by the slag reactor were increases in pH, decreases in ORP and DO, and the extensive removal of metal(loid)s. pH is a driver of microbial community formation and activity where the activity of sulfate-reducing bacteria is reduced below pH 4. The pH of the influent MIW averaged 2.6±0.1 throughout operation and ranged from 11.2 to 12.7 (average of 12.3±0.3) in the slag reactor effluent (FIG. 2A). The tight pH control by the slag reactor demonstrates its utility as a reliant and powerful alkalizing agent for MIW. The high pH of the slag reactor effluent was expected as pH values ranging from 10 to 13 have been previously reported in MIW treated abiotically by slag, however, due to the slag reactor effluent mixing with influent MIW in the mixing tank, the average influent pH in the settling tank (SRBR influent) was 5.0±1.0 a pH range expected to promote the growth of many strains of sulfate-reducing bacteria. Anaerobic conditions and ORP values<100 mV are characteristics of an environment suitable for sulfate reduction. The ORP of the influent MIW was ˜250 mV and decreased to an average of ˜300±10 mV in the slag effluent (FIG. 2D). Ca²⁺ and OH⁻ are released from slag after the hydrolysis of CaO, while OH⁻ is likely responsible for increased pH and metal(loid) precipitation, increased concentrations of Ca²⁺ ions, a common reducing agent, in the slag effluent was likely responsible for such a drastic decrease in ORP. Ca²⁺ concentrations in the slag effluent (330-1200 mg L⁻¹) were on average ˜3.3 times higher than that of the influent MIW (70-160 mg L⁻¹). Similarly, DO decreased from 8.0±0.6 mg L⁻¹ in the influent MIW to 5±1 mg L⁻¹ in the slag effluent. Since the ORP and DO increased to −47±97 mV and 8.1±0.4 mg L⁻¹ respectively in the settling tank, a system fully closed to the atmosphere may preserve the beneficial to sulfate reduction. Incorporation of a slag reactor in the configuration from this study increases MIW pH and decreased MIW ORP and DO, and has the potential to provide appropriate MIW characteristics to promote sulfate reduction in the SRBRs stage.

The slag reactor provided extensive total metal(loid) removal and individual metal(loid) removal from MIW prior to entering the SRBRs. The total metal(loid) concentration in the slag reactor effluent was <0.02 mg L⁻¹ throughout operation (FIG. 2M) with a total metal(loid) removal of >99.9% (Table 2). Similarly, the removal of individual metal(loid)s were >99.8% (Table 2). Slag has been reported to remove 99% of Fe and 98% of Al from MIW as oxides and hydroxides such as hematite (Fe₂O₃), goethite (FeO(OH)), gibbsite (Al(OH)₂), amorphous Al(OH)₃ and basaluminite (Al₄(OH)₁₀SO₄). Additionally, the removal of >95% of trace metals from MIW such as Cr, Co, Cd, Cu, Pb, Ni and Zn were attributed to co-precipitation or adsorption by Fe and Al minerals. After the re-introduction of metal(loid)s by mixing the slag reactor effluent and MIW, the slag effluent promoted an overall decrease of metal(loid)s from 72-173 mg L⁻¹ (average of 130±30 mg L⁻¹) in the influent MIW to 12-135 mg L⁻¹ (average of 60±30 mg L⁻¹) in the settling tank. In this two-stage system, the extensive metal(loid) removal of the slag reactor is advantageous to reduce the metal(loid) loading in the SRBRs.

### Effective MIW Treatment Response in the SRBR Stage

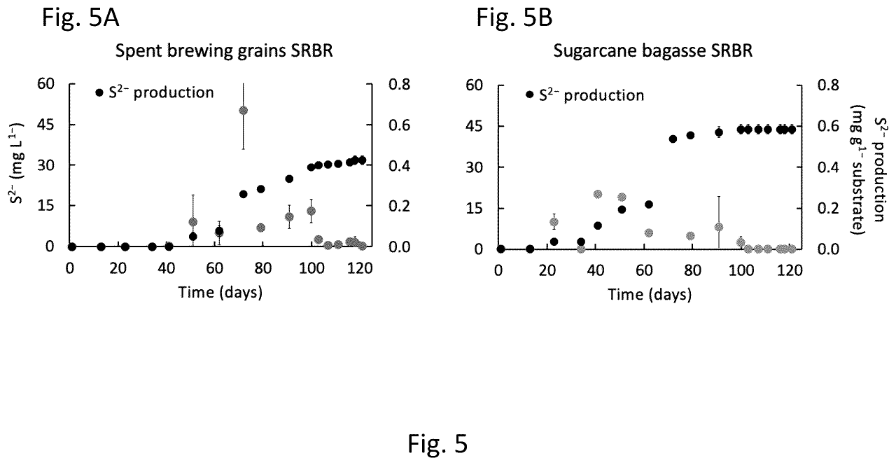

The second stage of the two-stage novel MIW treatment process evaluated SRBRs packed with either spent brewing grains or sugarcane bagasse receiving MIW from the settling tank (end of slag stage). SRBR operation commenced directly in continuous mode and the SRBRs were considered acclimated when S²⁻ was detected in the effluent as previously done. Acclimation was achieved by day 23 in the sugarcane bagasse SRBRs and by day 50 in the spent brewing grains SRBRs (FIG. 5A and FIG. 5B). While SO₄²⁻ was not removed at the slag stage (FIG. 2J), SO₄²⁻ mainly occurred in the SRBRs as seen in FIG. 2E-2F. Achieving specific water quality criteria was not the goal of this study, however the United States Environmental Protection Agency (US EPA) National Secondary Drinking Water Regulations non-mandatory SO₄²⁻ standard of 250 mg L⁻¹ was used as a benchmark for comparison of bioreactor SO₄²⁻ effluent concentrations. Sulfate-reducing bioreactors are often employed as part of a full-scale MIW treatment system therefore a comparison to specific water quality criteria can be scientifically useful but not necessarily applicable. In this study, SRBRs with spent brewing grains and sugarcane bagasse receiving MIW from the slag stage had an average effluent SO₄²⁻ concentrations of 150 and 300 mg L⁻¹ respectively during the operation phase (FIG. 2K and FIG. 2L), demonstrating the feasibility of the two-stage system to possibly achieve the potentially applicable SO₄²⁻ effluent benchmark. The spent brewing grains reached lower effluent SO₄²⁻ concentrations than the sugarcane bagasse SRBRs (FIG. 2K and FIG. 2L). Reoxidation of S²⁻ to SO₄²⁻ has been reported in many SRBRs systems and may have contributed to higher effluent SO₄²⁻ concentrations in the sugarcane bagasse SRBRs as DO loading was also higher in these bioreactors. However, when normalizing to the initial mass of lignocellulose, the sugarcane bagasse removed ˜3 times more SO₄²⁻ per dry material mass than the spent brewing grains by the end of operation (FIG. 2K-FIG. 2L, day 121). Results from this work clearly demonstrate that spent brewing grains and sugarcane bagasse possess distinct advantages for SO₄²⁻ removal and total metal(loid) precipitation in SRBRs.

TABLE 2
Metal(loid) concentrations in the two-stage MIW treatment from
this study. The data tabulated are metal(loid) concentrations
for the influent MIW, the slag stage effluent, and the effluent
from both SRBR stages during the operational phase (spent
brewing grains: 4.6 d HRT for days 38-121, sugarcane bagasse:
3.3 d HRT for days 35-121). ND = not detected.

| | | | | Spent | Sugar- |
|---|---|---|---|---|---|
| | | | | brewing | cane |
| | | | SRBR | grains | bagasse |
| | | Slag | influent | SRBR | SRBR |
| | MIW | reactor | (settling | stage | stage |
| Metal | influent | effluent | tank) | effluent | effluent |
| (loid) | (mg L⁻¹) | (mg L⁻¹) | (mg L⁻¹) | (mg L⁻¹) | (mg L⁻¹) |
| Al | 1.6-3.8 | ≤0.005 | ≤3.5 | ≤0.2 | ≤3.3 |
| As | ≤0.09 | ND | <0.008 | ≤0.02 | ND |
| Cd | 0.01-0.13 | ND | 0.03-0.1 | ≤0.001 | ≤0.002 |
| Co | ≤0.02 | ND | ≤0.01 | ≤0.03 | ≤0.01 |
| Cr | ≤0.05 | ND | ≤0.03 | ≤0.02 | ≤0.02 |
| Cu | 0.28-0.89 | ≤0.0006 | ≤1.2 | ≤0.06 | ≤0.05 |
| Fe | 33-77 | ≤0.0007 | ≤50 | 0.5-38 | ≤57 |
| Ni | ≤0.04 | ND | ≤0.02 | ≤0.05 | ≤0.03 |
| Pb | ≤0.03 | ND | ≤0.01 | ≤0.02 | ≤0.02 |
| V | 0.02-0.1 | ≤0.0002 | ≤0.06 | ≤0.05 | ≤0.05 |
| Zn | 37-92 | ≤0.02 | 12-80 | ≤10 | ≤1.7 |
| Total | 72-173 | 0.0004-0.02 | 12-135 | 0.5-39 | 0.04-58 |

The slag reactor effluent was responsible for removing the bulk of metal(loid)s from the influent MIW and the SRBRs provided additional overall metal(loid) removal. The outcome of overall metal(loid) removal by the two-stage system on a daily basis was similar between the two sets of SRBRs with the spent brewing grains SRBRs removing 94±7% and the sugarcane bagasse SRBRs removing 92±15% (Table 2). However, similar to the removal of SO₄²⁻, the sugarcane bagasse SRBRs removed 4.7 times more metal(loid)s per gram of sugarcane bagasse than the spent brewing grains SRBRs. Both the spent brewing grains and sugarcane bagasse SRBR stages showed preferential removal of Cd, Cu and Zn removal at >96% (Table 2). The solubility of Zn, Cu and Cd sulfide complexes between pH 5 and 12 is low (below 0.01 mg L⁻¹) and the solubility of their hydroxides is higher (>10 mg L⁻¹) at pH<7. These metals likely remained dissolved in the settling tank (average pH of 5±1) and were therefore immobilized in the SRBRs as sulfides. These outcomes underscore the importance of SRBR stage to target removal of metals not effectively removed by the slag stage. Results also highlight that the contribution of SRBRs in the two-stage treatment was complementary to the slag, providing additional SO₄²⁻ and metal(loid)s removal.

TABLE 3
Metal(loid) removal in the two-stage MIW treatment from this study.
The data tabulated show influent metal(loid) concentrations and
average removal (±SD) for the operational phase (spent brewing
grains: 4.6 d HRT for days 38-121, sugarcane bagasse: 3.3 d HRT
for days 35-121). Removal was calculated using the influent and
effluent concentrations during operation from Table 2.

| | | | | Sugarcane bagasse | |
|---|---|---|---|---|---|
| | Slag | Spent brewing grains | | SRBR | Two-stage |
| | reactor | SRBR | Two-stage | stage | treatment |
| Metal | removal (%) | stage | treatment | removal | removal |
| (loid) | 99.9 ± 0.1 | removal (%) | removal (%) | (%) | (%) |
| Al | >99.9 | 69 ± 39 | 98 ± 3 | 62 ± 39 | 91 ± 20 |
| As | >99.9 | — | 97 ± 11 | — | ≥99 |
| Cd | >99.9 | >99 | ≥99 | ≥99 | ≥99 |
| Co | >99.9 | 64 ± 50 | 68 ± 47 | 88 ± 35 | 92 ± 29 |
| Cr | 99.9 ± 0.1 | 67 ± 38 | 91 ± 15 | 65 ± 39 | 91 ± 16 |
| Cu | >99.9 | 98 ± 7 | ≥99 | 99 ± 6 | ≥99 |
| Fe | >99.9 | 14 ± 31 | 88 ± 13 | 32 ± 45 | 83 ± 32 |
| Ni | >99.9 | 67 ± 47 | 73 ± 42 | 89 ± 33 | 95 ± 18 |
| Pb | 99.8 ± 0.5 | 3 ± 7 | 73 ± 41 | 60 ± 55 | 78 ± 33 |
| V | 99.99 ± 0.01 | 9 ± 18 | 19 ± 27 | 10 ± 19 | 28 ± 31 |
| Zn | 99.99 ± 0.01 | 96 ± 15 | ≥99 | ≥99 | ≥99 |
| Total | 99.99 ± 0.01 | 78 ± 33 | 94 ± 7 | 86 ± 26 | 92 ± 15 |

### Slag Supports Enrichment of Sulfate-Reducing and Lignocellulose-Biodegrading Microbial Communities in the SRBR Stage

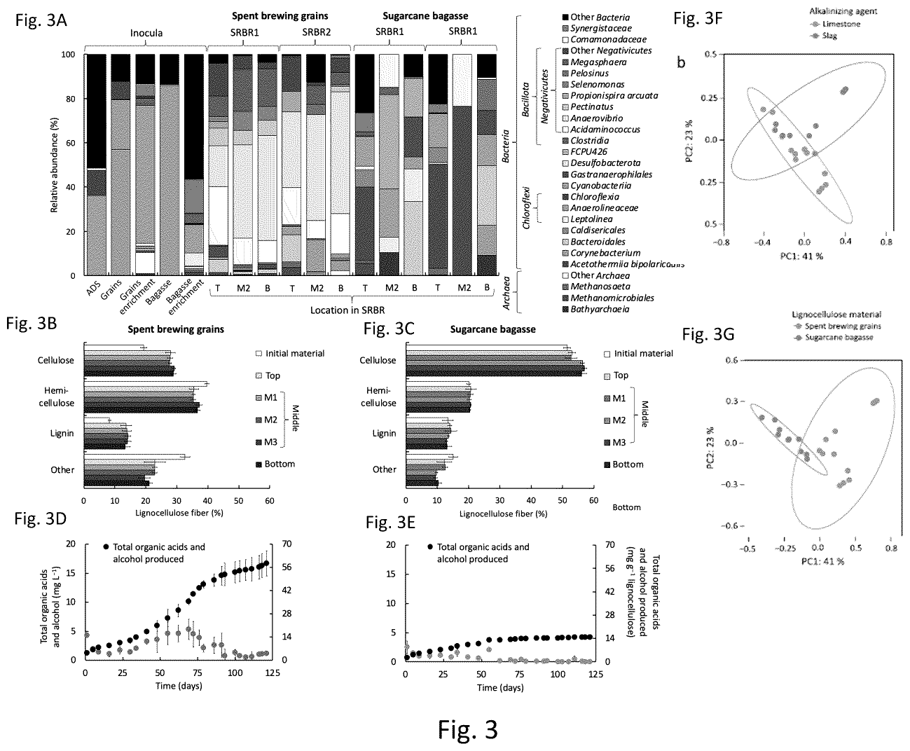

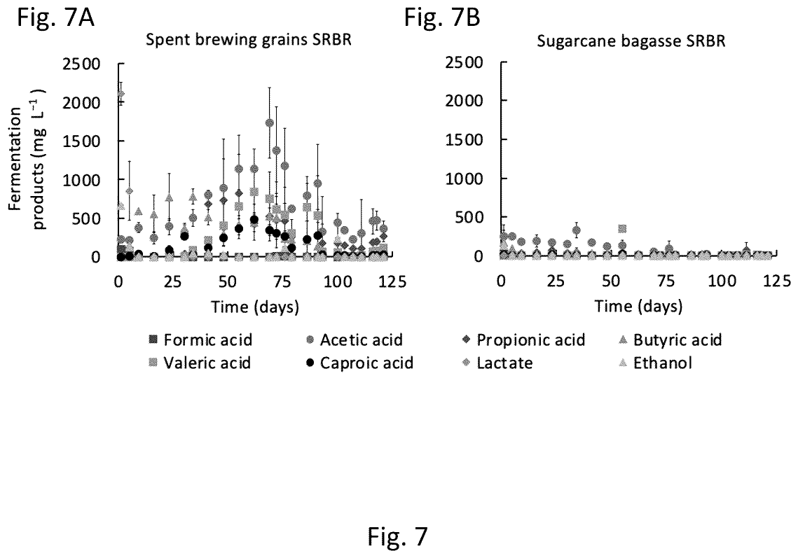

While a limited number of studies have used slag to enhance certain processes such as fermentation, denitrification or even sulfate reduction, none have characterized the microbial community composition of these systems. In this study, the microbial community composition and diversity was determined by the lignocellulosic material (FIG. 3A). Desulfobacterota containing identified sulfate-reducing species were common to both sets of SRBRs, however, known fermentative and hydrolytic bacteria enriched in the spent brewing grains or the sugarcane bagasse SRBRs were unique to each material. Negativicutes class made up 70-94% of total relative abundances in the spent brewing grains SRBRs with genus Anaerovibrio making up 18-55% of the total sequences. Anaerovibrio has been reported in SRBRs packed with a mixture of spent brewing grains and limestone. Anaerovibrio spp. ferment lactate, ribose, and fructose to acetate, propionate, C02, H₂, and succinate. The activity of putative Anaerovibrio and other fermenters was reflected in the high concentrations of acetic and propionic acids in the effluent of the spent brewing grains SRBRs from this study (FIG. 7A). In the sugarcane bagasse SRBRs, class Anaerolineaceae made up ˜14-30% of the total sequence abundance with genus Leptolinea at 15% of the total ASVs (FIG. 3A). Leptolinea spp. are capable of fermenting sugars and proteins and have been detected in waste activated sludge containing high concentrations of lignocellulose. Most commonly, SRBRs treating MIW enrich a microbial community mainly composed of Bacillota (formerly known as Firmicutes) and Bacteroidota (formerly known as Bacteroidetes) as the major fermentative and hydrolytic phyla. In this study, the functional redundancy of the SRBR microbial community is retained (SO₄²⁻ reduction, lignocellulose biodegradation) when SRBRs receive MIW pre-treated by slag. However, the specific enriched taxa, particularly for hydrolytic and fermentative bacteria, are different than in SRBR where limestone was added as an alkalizing agent.

In a previous study, limestone (at 30 wt %) was used as the alkalinizing agent in SRBRs packed with spent brewing grains or sugarcane bagasse to treat the same MIW as used in this study. The SRBRs with limestone were also operated at similar HRTs (between 3 and 12 days). To understand if the alkalinizing agent (slag versus limestone) plays a role in the resulting microbial communities in SRBRs, the sequences from this study were combined with the data from the previous study. According to the weighted UniFrac analysis (FIG. 3F and FIG. 3G), the type of lignocellulose material (spent brewing grains or sugarcane bagasse) was a stronger driver of the microbial community composition than the type of alkalinizing agent. This outcome, combined with the evidence for the essential microbial metabolisms (SO₄²⁻ reduction, anaerobic lignocellulose biodegradation) found in typical lignocellulosic SRBRs strongly suggests that slag is a viable alternative to limestone as the alkalinizing agent.

MIW treatment in the SRBR stage relies on fermentative and hydrolytic bacterial ability to break down the lignocellulosic components of spent brewing grains and sugarcane bagasse to electron donors (e.g., H₂, organic acids, alcohols) for sulfate-reduction. The lignocellulose components (cellulose, hemicellulose, lignin) were grouped and non-lignocellulosic components were grouped into ‘other’ (sugars, starches, proteins etc.) before and after SRBR operation (FIG. 3B-C). Before operation, hemicellulose made up most of the spent brewing grains with 40±1% (FIG. 3B). At the end of SRBR operation (day 121), hemicellulose composition decreased by ˜4% (36±1%) of the total composition, while ‘other’ decreased by ˜10% (from 32±2%, FIG. 3B). SRBRs containing spent brewing grains and 30% limestone exhibited a similar change in hemicellulose and other after 135 days of operation. In sugarcane bagasse, cellulose initially made up 51±1% of the lignocellulose composition (FIG. 3C). After operation, only the ‘other’ category decreased by ˜5% in the sugarcane bagasse SRBRs (from 15±1% FIG. 3C, implying limited lignocellulose degradation by the microbial community. This was also evident by the reduction in organic acid and alcohol availability throughout operation (FIG. 3E). Previous studies have associated the higher availability of organic acids and alcohols to higher extents of SO₄²⁻ reduction in SRBRs treating MIW. High concentrations of propionic acid have also been correlated with inadequate SO₄²⁻ reduction in an up-flow anaerobic sludge blanket bioreactor treating sulfate-rich water. While a variety of organic acids and alcohols from the biodegradation of lignocellulose were detected in the SRBR effluents, acetic acid was consistently higher in concentration compared to propionic acid (FIG. 7A-FIG. 7B), supporting good performance for SO₄²⁻ reduction and the potential for a novel two-stage treatment process incorporating a slag and sulfate reduction to treat MIW.

### Incorporating Slag and SRBRs for MIW Treatment: Prospects for Future Implementation at Mining Sites

The capacity of slag for acid neutralization is beneficial where pH control is necessary for microbial processes to carryout effective water treatment (e.g., denitrification, sulfate-reduction, fermentation). Previous studies demonstrate potential for full-scale implementation by successfully treating Al, Fe, Mn, and Mg in MIW collected from two mining sites. In this two-stage treatment (FIG. 1), the slag stage featured a single slag reactor in recirculation with a mixing tank which received MIW and flowed into a settling tank. Settling of precipitates in the settling tank alleviated metal(loid) loading to the SRBRs mitigating sludge buildup in the SRBRs and reducing possible clogging (pipes, SRBR, etc.) ultimately increase the lifetime of the SRBRs for MIW treatment.

The single pass through each stage was a key design in this two-stage treatment system. The partial recycling of the effluent through the entire system in the configuration from previous studies made it difficult to determine the specific treatment capacities of the slag and SRBRs. The distinct two-stage configuration from this study facilitated the assessment of treatment by its individual components (pH, metal(loid)s, SO₄⁻² at the slag and SRBR stages). Each stage demonstrated its capacity to treat MIW, where the slag stage was exceptional at removing metal(loid)s as hydroxides and oxides as well as increasing MIW pH, the SRBR stage focused on removing sulfate and any remaining metals as more stable sulfide precipitates. While the SRBRs from this study reached an average SO₄⁻² effluent concentration in the range of the 250 mg L⁻¹ (benchmarked, non-mandatory standard), future two-stage configurations targeting MIW treatment may consider a design where anoxic conditions are more tightly controlled at the slag stage such as increasing SRBR HRT allowing anaerobic conditions to prevail. Additionally, S²⁻ re-oxidation was likely occurring in the SRRBs due to the amount of reduced metal(loid) concentrations entering the SRBRs, a great outcome of the slag reactor MIW treatment. The concentrations of metal(loid)s from the MIW used in this study may have been too low for the amount of sulfide produced, therefore this two-stage system may be capable of treating MIW with higher concentrations of metal(loid)s.

The two types of lignocellulosic materials used in this study had distinct advantages when treating the MIW. The spent brewing grains SRBRs removed metal(loid)s and SO₄²⁻ at higher daily rates while the sugarcane bagasse SRBRs removed more SO₄²⁻ and metal(loid)s per unit mass of dry lignocellulosic. Based on these observations, a combination of the two materials may be beneficial to meet strict daily metal(loid) and SO₄²⁻ effluent concentrations in an SRBR system designed for years or decades of operation in the field. In this work, the slag stage was decoupled from the SRBRs to more tightly control SRBR influent pH. Configurations where slag is directly combined with the lignocellulosic material (similar to limestone) may also be feasible. However, such endeavors will require preliminary studies to fine tune the amount of slag needed to maintain a circumneutral pH within the SRBR. Overall, this study supports the feasibility of using basic oxygen furnace slag in combination with SRBRs for full-scale treatment of MIW at remote mining sites.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A method of purifying contaminated fluid influent, the method comprising:
providing a reactor comprising a reactor inlet, a reactor outlet, and a purification composition;
circulating contaminated fluid influent through the reactor to create a slag-treated fluid;
providing a biochemical reactor comprising a biochemical reactor inlet, a biochemical reactor outlet, and a purification media; and
circulating the slag-treated fluid through the biochemical reactor to generate a purified fluid.

2. The method of claim 1, wherein the purified fluid is collected.

3. The method of claim 1, wherein the purification composition comprises slag and a dispersing component.

4. The method of claim 3, wherein the slag is a basic oxygen furnace slag.

5. The method of claim 1, wherein the purification media comprises a lignocellulosic component and sulfate reducing bacteria.

6. The method of claim 1, wherein the slag-treated fluid has a pH of at least 4.

7. The method of claim 1, further comprising the step of pumping the slag-treated fluid to a mixing tank which contains contaminated fluid influent.

8. The method of claim 7, further comprising the step of mixing the slag-treated fluid with contaminated fluid influent in the mixing tank to create a mixed stream.

9. The method of claim 8, further comprising the step of partially recycling the mixed stream back through the reactor inlet.

10. The method of claim 8, further comprising the step of passing the mixed stream to a settling tank to create a pretreated fluid.

11. The method of claim 10, further comprising the step of passing the pretreated fluid to and through the biochemical reactor to generate a purified fluid.

12. The method of claim 11, wherein the pretreated fluid comprises less metal(loids) than the mixed stream.

13. A contaminated fluid influent purification system, comprising:
a reactor having a reactor inlet, a reactor outlet, and a purification composition;
a biochemical reactor having a biochemical reactor inlet, a biochemical outlet, and a purification media;
a settling tank; and
a mixing tank;
wherein the mixing tank is fluidly connected to a contaminated fluid influent source, the reactor and the settling tank; and
wherein the settling tank is fluidly connected to the mixing tank and the biochemical reactor.

14. The contaminated fluid influent purification system of claim 13, wherein the purification composition comprises slag and a dispersing component.

15. The contaminated fluid influent purification system of claim 14, wherein the slag is a basic oxygen furnace slag.

16. The contaminated fluid influent purification system of claim 13, wherein the purification media comprises a lignocellulosic component and sulfate-reducing bacteria.

17. The contaminated fluid influent purification system of claim 16, wherein the lignocellulosic component comprises sugarcane bagasse.

18. The contaminated fluid influent purification system of claim 16, wherein the lignocellulosic component comprises spent brewing grains.

19. The contaminated fluid influent purification system of claim 13, wherein the contaminated fluid influent comprises fluid contaminated with metals.

20. The contaminated fluid influent purification system of claim 13, wherein the contaminated fluid influent comprises mining influenced water.
